(19) United States
(12) Patent Application Publication
(10) Pub. No.: US 2009/0307404 A1
(43) Pub. Date: Dec. 10, 2009

(54) APPLIANCES FOR HEATING AND COOLING LIQUIDS

(76) Inventor: Roger Payn, Cambridgeshire (GB)

Correspondence Address: BROOKS KUSHMAN P.C., 1000 TOWN CENTER, TWENTY-SECOND FLOOR, SOUTHFIELD, MI, 48075, US

(21) Appl. No.: 11/721,560

(22) PCT Filed: Dec. 21, 2005
(86) PCT No.: PCT/GB2005/050259

§ 371 Date: Jun. 13, 2007

(30) Foreign Application Priority Data
Dec. 23, 2004 (GB) 0428106.9

(51) Int. Cl. G06F 13/00; G06F 1/26; G01K 13/00; G05D 23/19

(52) U.S. Cl. 710/304; 713/300; 702/130; 700/300

(57) ABSTRACT

It has been proposed in the past to provide a series of different cordless appliances, any one of which will fit onto a docking station or base unit from which power is supplied. The invention provides a data connection (4, 12) between the base unit (1) and the cordless appliance (9) so that the base unit (1) knows what appliance is currently in use. This allows a control system (12) to be fitted in the base unit (1) that is sufficiently sophisticated to be able to control any of the cordless units, the identity of the unit (9) currently in use, and therefore the way in which it is to be controlled, being derived via the data connection (4, 12).

This invention relates to a system for heating and/or cooling liquids particularly in the field of domestic appliances.

Within recent years it has become popular to make some domestic appliances in two parts: a base, fitted with a standard plug to receive a mains power supply; and a removable container for a liquid which makes electrical contact with the base and yet can be easily removed for pouring. Such appliances are commonly referred to as ‘cordless,’ because the removable container has no electric cable attached to it. These cordless appliances are usually simple kettles designed to raise water to boiling point and then switch off.

Proposals have been made in the past for cordless systems having a single base unit that will receive any one of a number of different appliances. An example of this is described in patent specification WO 96/22718. Another example is described in US2003/0092322 where the base unit is formed with a number of stations where different appliances can be received interchangeably.

In these past proposals the base unit does little more than support the appliance physically and to supply power to it. Any control mechanisms need to be incorporated into the design of the individual appliance, depending of course on its function.

According to this invention there is provided a system for heating and/or cooling liquids comprising a docking station and a plurality of electrical appliances designed to fit onto and to receive power from the docking station, the appliances being designed to perform respective different functions, characterised by an interface arrangement that provides a data connection allowing the docking station to derive information concerning the appliance currently in use.

It is preferred that the docking station should act as a physical support for the docked appliance but this is not essential providing suitable arrangements are made for electrical and data connections.

The invention makes it economically feasible to employ a highly sophisticated control system within the docking station, thereby, adding to the functionality of each of the appliances and eliminating the need to have complex controls duplicated within each individual appliance. For example, one appliance might be a simple electric kettle requiring only to be switched off when the water boils. Another might be a coffee or tea maker requiring a number of different switching operations to be performed under the control of the base unit depending on measured time intervals and/or temperature measurements etc. Another appliance might be a wine or drink chiller where the base unit senses the current temperature of the drink and switches power on when the temperature rises above a threshold value. The docking station may be provided with a facility for the entry of user-defined requirements such as a desired temperature.

The data connection can take any one of many different possible forms. For example, a physical set of contacts on the appliance and the docking station could be arranged to engage when the appliance is docked. Another possibility would be to multiplex data signals onto the same conductors as are used to supply electrical power. Another possibility would be to employ an optical or infrared link between the docking station and the appliances. Other possibilities include inductive loops such as have been proposed in use in contactless smart cards. Yet another possibility would be to use short-range radio communication systems such as are available under the protocol known as Bluetooth™.

Where a data connection is provided, many different useful functions can be included in the system. For example, each appliance can be designed to carry a code, which indicates its identity. This code could identify the appliance as being a simple kettle for boiling water or a milk warmer for heating milk to a temperature lower than boiling point. Instead of a code, each appliance could be designed so that its physical shape allows the docking station to identify it. Yet another possibility would be for the docking station to be designed to identify the appliance from electrical characteristics of the heating or cooling mechanism. For example, the docking station might detect electrical resistance of the power circuit and make a deduction about the identity of the appliance from this. The docking station could then include a control system which

a) interrogates a docked appliance,

b) downloads temperate information from the appliance,

c) invites the user to enter preferences (e.g. the desired temperature of milk to be heated) and

d) controls the supply of power to the appliance to achieve the desired effect e.g. switching off the power when a set temperature is reached or controlling the speed of heating.

This control system can also include means for notifying the user when an operation is completed, for example, an audible signal can be given. This signal could be a simple tone, synthesised speech or displayed text.

It is envisaged that each appliance will normally include its own heating or cooling mechanism. In some variations it may be desirable for the docking station also to include a heating and/or cooling mechanism. For example, a coffee maker might contain an integral heater, whilst the docking station also includes a hotplate for maintaining the temperature after percolation.

One way in which the invention may be performed will now be described by way of example with reference to the accompanying drawings in which:

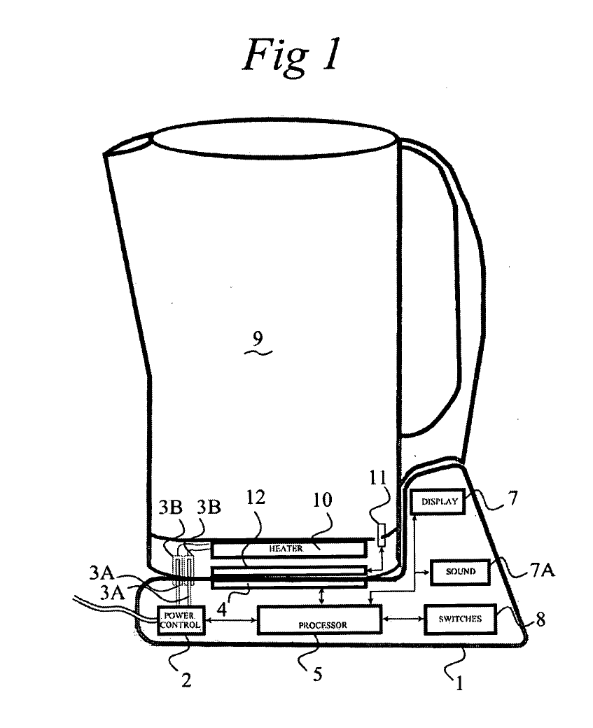

FIG. 1 illustrates, very schematically, a docking station constructed in accordance with the invention and a kettle supported by it; and

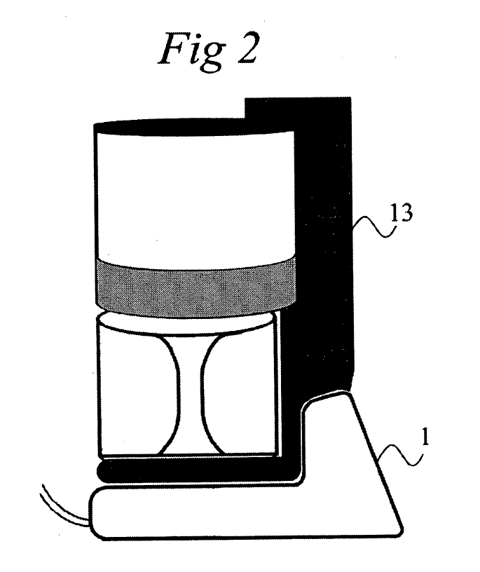

FIG. 2 is similar to FIG. 1 but illustrating a coffee maker supported on the same docking station as FIG. 1.

Referring first to FIG. 1 there is shown a base unit or docking station 1 which receives power from a conventional domestic mains electricity supply. This is fed via a switch 2, which has a default OFF position, to two contact pins 3A, which project from an upper support surface of the docking station. Also adjacent to this upper surface is an inductive loop 4, which co-operates with an associated loop in an appliance in a manner to be described later.

A processor 5 is linked to a user interface system comprising in this embodiment a display 7, an audible sounder 7A and a switch panel 8.

Supported on the base 1, there is shown on FIG. 1, a simple electric kettle 9. This receives power from contacts 3B and these are connected to heater 10 embedded in a solid base of the kettle. Also embedded in this base, is a temperature sensor 11 which projects into the cavity for receiving water, and an electronic unit 12 linked to the temperature sensor.

The electronic unit 12 contains a microprocessor, a read-only memory and an inductive loop. The latter allows data to be transmitted between the units 1 and 9 and also allows a small amount of power to be transmitted to provide a low voltage power supply for the unit 12. The memory contains information defining the identity of the kettle and instructions or data to allow the docking station to control its operation correctly. This takes the form of a program which controls operation of the docking station in a way appropriate to the particular appliance. The unit 12 is built on principles, which are known for use in so called contactless smart cards.

In operation, an appliance such as the illustrated kettle 9 is placed on the docking station 1 and an on/off switch at 8 operated. This then caused the processor to follow a routine as follows.

First the processor, through the inductive coupling provided by elements 4 and 12, addresses the memory in unit 12 and extracts from it the identity of the unit 9 and certain characteristics of it. In the case of the simple kettle illustrated, this information is simply that the water in the kettle should be raised to boiling point and allowed to boil for a short defined period thereafter.

If no unit 9 is detected, the switch 2 remains in its OFF position, ensuring that exposed contacts 3A are never live. If, however, a unit 9 is detected, the processor then operates the switch 2, causing the heater 10 to heat water in the kettle 9. It then monitors the temperature as measured at 11. When the detected temperature reaches 100 degrees, the processor waits for the defined delay, ensuring that the water has been boiled for sufficient time for sterilization. The power is then switched off at 2 and an indication given to the user, via units 7 and 7A, that the boiled water is ready for use.

FIG. 2 shows a coffee maker 12 supported on the same docking station 1 as shown on FIG. 1. In this case, the information extracted from the electronic unit, equivalent to that shown at 12 on FIG. 1, includes an instruction to ask the user certain questions such as the quantity of water in the coffee maker and whether the coffee will all be used immediately after making or whether it should be kept hot. These questions are asked using the visual display 7 and the user enters responses using switch controls 8. The processor is then controlled by the program within the unit 12, and by the responses from the user, to continue boiling the water for sufficient time to ensure that it is all pumped by steam pressure onto the coffee grounds. The switch 2 is then set to a position where it switches power to an ancillary heater to keep the percolated coffee at an acceptable drinking temperature.

It will be appreciated that a kettle and coffee maker have been described only by way of example and that many other appliances can be used with the same docking station. Examples are wine chillers or warmers, water chiller, brandy warmer, baby milk warmer and saucepans. For these appliances, the user would be asked, under the control of the program contained within the unit 12, to specify the temperature required and possibly the nature of the liquid to be heated. The heating operation would then be controlled in a way appropriate to the liquid and to the personal preferences of the user, the current temperature being indicated to the user on the display 7. Because the temperature can always be raised or lowered just to the temperature required, and no further, it is possible to achieve, by using the invention, the optimum economy of energy utilization.

1. A system for heating and/or cooling liquids comprising a docking station and a plurality of electrical appliances designed to fit onto and to receive power from the docking station, the appliances being designed to perform respective different functions, characterised by an interface arrangement that provides a data connection allowing the docking station to derive information concerning the appliance currently in use including the appliance's identity.

2. A system according to claim 1 characterised in that each appliance comprises means to communicate information regarding its identity to the docking station.

3. A system according to claim 2 characterised in that each appliance contains instructions or a program for controlling operation of the docking station.

4. A system according to claim 2 characterised in that the docking station contains instructions or a program for controlling operation of the docked appliance depending on the identity of that appliance as communicated via the data connection.

5. A system according to claim 2 characterised in that each appliance has means to produce a signal indicative of the temperature of liquid contained within the appliance and comprises means to transmit that signal to the docking station.

6. A system according to claim 5 further characterised by a user interface within the docking station designed to present a user with a set of options appropriate to the identity of the appliance that is currently docked and to receive responses from a user.

7. A system according to claim 1 further characterised by a control system forming part of the docking station allowing the user to regulate the temperature of a liquid contained within a docked appliance.

8. A system according to claim 1 further characterised in that the docking station comprises means for indicating to a user information concerning temperature of liquid in a docked appliance.

9. An appliance for use in system according to claim 1.

10. A docking station for use in a system according to claim 1.

11. A system according to claim 3 characterised in that the docking station contains instructions or a program for controlling operation of the docked appliance depending on the identity of that appliance as communicated via the data connection.

12. A system according to claim 3 characterised in that each appliance has means to produce a signal indicative of the temperature of liquid contained within the appliance and comprises means to transmit that signal to the docking station.

13. A system according to claim 12 further characterised by a user interface within the docking station designed to present a user with a set of options appropriate to the identity of the appliance that is currently docked and to receive responses from a user.

14. A system according to claim 4 characterised in that each appliance has means to produce a signal indicative of the temperature of liquid contained within the appliance and comprises means to transmit that signal to the docking station.

15. A system according to claim 14 further characterised by a user interface within the docking station designed to present a user with a set of options appropriate to the identity of the appliance that is currently docked and to receive responses from a user.

16. A system according to claim 2 further characterised by a control system forming part of the docking station allowing the user to regulate the temperature of a liquid contained within a docked appliance.

17. A system according to claim 3 further characterised by a control system forming part of the docking station allowing the user to regulate the temperature of a liquid contained within a docked appliance.

18. A system according to claim 4 further characterised by a control system forming part of the docking station allowing the user to regulate the temperature of a liquid contained within a docked appliance.

19. A system according to claim 5 further characterised by a control system forming part of the docking station allowing the user to regulate the temperature of a liquid contained within a docked appliance.

20. A system according to claim 6 further characterised by a control system forming part of the docking station allowing the user to regulate the temperature of a liquid contained within a docked appliance.
